(19) United States
(12) Patent Application Publication
(10) Pub. No.: US 2010/0109281 A1
(43) Pub. Date: May 6, 2010

(54) Bicycle handle and system and method for transporting an additional rider on a bicycle

(75) Inventor: Royal Johnson, Chicago, IL (US)

Correspondence Address: PATENTS+TMS, P.C., 2849 W. ARMITAGE AVE., CHICAGO, IL, 60647, US

(73) Assignee: Stephen Ramsay

(21) Appl. No.: 12/291,136

(22) Filed: Nov. 6, 2008

(51) Int. Cl. B62K 21/00

(52) U.S. Cl. 280/270; 74/492

(57) ABSTRACT

A bicycle handle and a system and a method transport an additional rider on a bicycle. The bicycle handle reversibly attaches to a seat post of the bicycle. A height of the bicycle handle adjusts to correspond to a height of the additional rider. The bicycle handle has a “T” shape that connects to the seat post of the bicycle. The bicycle handle has portions for gripping by the additional rider. The additional rider may be transported with pegs for feet of the additional rider that attach to the bicycle. The pegs fold down if not in use. The pegs extend in a direction forward and/or rearward to allow the foot of the additional rider to rest on the pegs.

### BACKGROUND OF THE INVENTION

The present invention generally relates to a bicycle handle and a system and a method for transporting an additional rider on a bicycle. More specifically, the present invention relates to a bicycle handle that reversibly attaches to a seat post of the bicycle. A height of the bicycle handle may be adjustable so that the height of the bicycle handle corresponds to a height of the additional rider. The bicycle handle may have a “T” shape wherein a base of the “T” connects to the seat post of the bicycle. The system and the method for transporting the additional rider may have pegs for feet of the additional rider that attach to the bicycle.

It is generally known to transport a rider on a standard bicycle, a tricycle, a motorcycle or other like vehicle. The standard bicycle has one seat. The seat is attached to a frame of the bicycle by a vertical seat post. Tandem bicycles that have two seats are also well known. However, the tandem bicycle may require more space for storage than available and may make riding difficult and/or impossible for a single rider. To transport an additional rider, pegs are attached to the rear axle of the standard bicycle. The pegs extend in a perpendicular direction from the plane of the bicycle tire. An additional rider stands on one or more of the pegs with each leg on one side of the rear tire and a foot on each peg. The pegs support the weight of the additional rider. Thus, the rider and the additional rider are transported by the bicycle.

The additional rider usually maintains his/her balance by holding onto the back and/or the shoulders of the rider. Maintaining balance may be difficult for the additional rider, especially during movement of the back and/or the shoulders of the rider, if the bicycle turns and/or if the bicycle traverses irregularities in the road. Further, the additional rider holding the back and/or the shoulders may limit the movement of the rider and may make pedaling and/or steering of the bicycle difficult for the rider. If the rider drives the bicycle for an extended period while being grasped by the additional rider, then the rider may become tired. A tired rider may not adequately control the bicycle.

Further, the pegs are typically a round rod-like shape. The round rod-like shape of the pegs makes maintaining balance difficult for the additional rider. Still further, the pegs extend from the bicycle and may contact objects passed by the bicycle which may push the bicycle over and/or alter the course of the bicycle.

A need, therefore, exists for a bicycle handle and a system and a method for transporting an additional rider on a bicycle. A further need exists for a bicycle handle that is reversibly attachable to the seat post of the bicycle. Still further, a need exists for a bicycle handle that has an adjustable height. The bicycle handle may have a “T” shape wherein a base of the “T” connects to the seat post of the bicycle. Moreover, a need exists for a system and a method for transporting an additional rider that have pegs for feet of the additional rider that attach to the bicycle. A need exists for pegs that have an upper surface that is flat and that may fold if not in use.

### SUMMARY OF THE INVENTION

The present invention generally relates to a bicycle handle and a system and a method for transporting an additional rider on a bicycle. More specifically, the present invention relates to a bicycle handle that reversibly attaches to a seat post of the bicycle. A height of the bicycle handle may be adjustable so that the height of the bicycle handle corresponds to a height of the additional rider. The bicycle handle may have a “T” shape wherein a base of the “T” connects to the seat post of the bicycle. The bicycle handle may have portions for comfortable gripping by the additional rider. The system and method for transporting the additional rider may have pegs for feet of the additional rider that attach to the rear axle of the bicycle. The pegs may have an upper surface that is flat. The pegs may fold if not in use. The upper surface of the pegs may extend in a forward direction and/or a rearward direction to allow an entirety of the surface of the foot of the additional rider to rest on the upper surface of the pegs.

To this end, in an embodiment of the present invention a bicycle handle for attachment to a bicycle is provided. The bicycle has a front end, a back end, a first handle, a front wheel located at the front end, a back wheel located at the back end, a seat and a seat post wherein the first handle is adjacent to the front wheel wherein the seat is connected to the back wheel by the seat post and further wherein the bicycle handle attaches to the seat post in a position adjacent to the back wheel and the back end. The bicycle handle has a post having a first end and a second end wherein the first end and the second end define a length of the post. Further, the bicycle handle has a first handlebar that extends from the first end of the post wherein the first handlebar is substantially perpendicular to the post. Still further, the bicycle handle has a second handlebar that extends from the first end of the post wherein the second handlebar is substantially perpendicular to the post. Moreover, the bicycle handle has connecting means attached to the second end of the post.

In an embodiment, the bicycle handle has a first rod and a second rod wherein the first rod and the second rod form the post and further wherein movement of the first rod relative to the second rod adjusts the length of the post.

In an embodiment, the bicycle handle has a latch that extends from the connecting means wherein the latch moves between a first position and a second position.

In an embodiment, the bicycle handle has handle portions on the first handlebar and the second handlebar wherein the first handlebar and the second handlebar are manufactured from a first material, the handle portions are manufactured from a second material and the second material is softer than the first material.

In an embodiment, the bicycle handle has a fastener attached to the connecting means wherein the connecting means has an open configuration and a closed configuration and adjustment of the fastener moves the connecting means between the open configuration and the closed configuration.

In an embodiment, the bicycle handle has a latch on the post wherein the latch moves between a first position and a second position wherein moving the latch from the first position to the second position adjusts the length of the post.

In another embodiment of the present invention, a system for transporting an additional rider on a bicycle is provided. The bicycle has a first handlebar, a front wheel, a rear wheel, a seat and a seat post wherein the first handlebar is adjacent to the front wheel and the seat is connected to the rear wheel by the seat post and further wherein the system attaches to the seat post in a position adjacent to the back wheel. The system has a post having a first rod and a second rod wherein the first rod has a first end and a second end and the second rod has a first end and a second end and further wherein the second end of the second rod is connected to the first end of the first rod and further wherein a length of the post is defined by a distance between the first end of the second rod and the second end of the first rod. Further, the system has a third rod that extends from the first end of the second rod; and a fourth rod that extends from the first end of the second rod. Still further, the system has connecting means attached to the second end of the second rod.

In an embodiment, the system has a spring connected to the first rod and the second rod.

In an embodiment, the system has an opening at the first end of the first rod wherein the second end of the second rod is located within the opening.

In an embodiment, the system has a latch on the post wherein the latch moves between a first position and a second position wherein moving the latch from the first position to the second position adjusts the length of the post.

In an embodiment, the system has a button on the post wherein pressing the button allows movement of the first rod relative to the second rod.

In an embodiment, the system has pegs adjacent to the connecting means wherein each of the pegs has a flat surface.

In an embodiment, the system has pegs adjacent to the connecting means wherein each of the pegs rotates from a horizontal position to a downward position.

In another embodiment of the present invention, a method for transporting an additional rider on a bicycle is provided. The bicycle has a first handle, a seat post, a front wheel and a rear wheel wherein the first handle is adjacent to the front wheel. The method has the steps of: connecting a second handle to the seat post wherein the second handle has a post having a first end and a second end and further wherein the first end and the second end define a length of the post wherein a first handlebar and a second handlebar are connected to the first end of the post and further wherein the second end of the post connects to the seat post of the bicycle wherein the second handle has a connector attached to the second end of the post wherein the connector attaches to the seat post of the bicycle and de-attaches from the seat post of the bicycle; and moving the bicycle wherein the bicycle is moved with the additional rider holding the second handle.

In an embodiment, the method has the step of adjusting the length of the post of the second handle.

In an embodiment, the method has the step of attaching pegs to the rear wheel of the bicycle wherein each of the pegs has a flat surface.

In an embodiment, the method has the step of attaching pegs to the rear wheel of the bicycle wherein the pegs rotate from a downward position to a substantially horizontal position.

In an embodiment, the method has the step of moving a latch on the post of the second handle from a first position to a second position wherein the first position is located opposite to the second position.

In an embodiment, the method has the step of moving a latch on the connector from a first position to a second position wherein the first position is located opposite to the second position.

In an embodiment, the method has the step of removing the second handle from the bicycle wherein de-attaching the connector from the seat post removes the second handle from the bicycle and further wherein reconnecting the connector to the seat post of the bicycle re-attaches the second bicycle handle to the bicycle.

It is, therefore, an advantage of the present invention to provide a bicycle handle and a system and a method for transporting an additional rider on a bicycle.

Another advantage of the present invention is to provide a bicycle handle reversibly attachable to a seat post of the bicycle.

Still another advantage of the present invention is to provide a bicycle handle having an adjustable height.

Yet another advantage of the present invention is to provide a bicycle handle having portions for comfortable gripping by an additional rider.

A still further advantage of the present invention is to provide a system and a method for transporting an additional rider that has pegs that attach to the bicycle.

Moreover, an advantage of the present invention is to provide a system and a method for transporting an additional rider that has pegs having an upper surface that is flat.

Another advantage of the present invention is to provide a system and a method for transporting an additional rider that has pegs that fold if not in use.

A still further advantage of the present invention is to provide a system and a method for transporting an additional rider that has pegs having an upper surface that extends forward and/or rearward to allow an entirety of the surface of the foot of the additional rider to rest on the upper surface of the pegs.

Yet another advantage of the present invention is to provide a bicycle handle and a system and a method for transporting an additional rider that allows the rider to be free from the grasp of the additional rider.

A still further advantage of the present invention is to provide a bicycle handle and a system and a method for transporting an additional rider that allows the additional rider to maintain their balance while in a standing position on the bicycle.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective side view of an embodiment of the present invention showing a system attached to a bicycle.

FIG. 2 illustrates a perspective side view of an embodiment of the present invention showing a footpeg attached to a bicycle.

FIG. 3A illustrates a front view of an additional bicycle handle in an embodiment of the present invention.

FIG. 3B illustrates a front view of an additional bicycle handle in an embodiment of the present invention.

FIG. 4 illustrates a top view of an additional bicycle handle in an embodiment of the present invention.

FIG. 5 illustrates a perspective view of a connector for an additional bicycle handle in an embodiment of the present invention.

FIG. 6A illustrates a perspective view of a connector for an additional bicycle handle in an embodiment of the present invention.

FIG. 6B illustrates a perspective view of a connector for an additional bicycle handle in an embodiment of the present invention.

FIG. 7 illustrates a top view of an embodiment of the present invention showing a footpeg attached to a bicycle.

FIG. 8A illustrates a side view of an embodiment of the present invention showing a footpeg attached to a bicycle.

FIG. 8B illustrates a side view of an embodiment of the present invention showing a footpeg attached to a bicycle.

### DETAILED DESCRIPTION OF THE PRESENTLY PREFERRED EMBODIMENTS

The present invention generally relates to a bicycle handle and a system and a method for transporting an additional rider on a bicycle. More specifically, the present invention relates to a bicycle handle that may reversibly attach to a seat post of the bicycle. A height of the bicycle handle may be adjustable so that the height of the bicycle handle corresponds to a height of the additional rider. The bicycle handle may have a “T” shape wherein a base of the “T” connects to the seat post of the bicycle. The bicycle handle may have portions for comfortable gripping by the additional rider. The system and the method for transporting the additional rider may have pegs for feet of the additional rider that may attach to the bicycle. The pegs may have an upper surface that is flat. The pegs may fold if not in use. The upper surface of the pegs may extend in a forward direction and/or a rearward direction to allow an entirety of the surface of the foot of the additional rider to rest on the upper surface of the pegs.

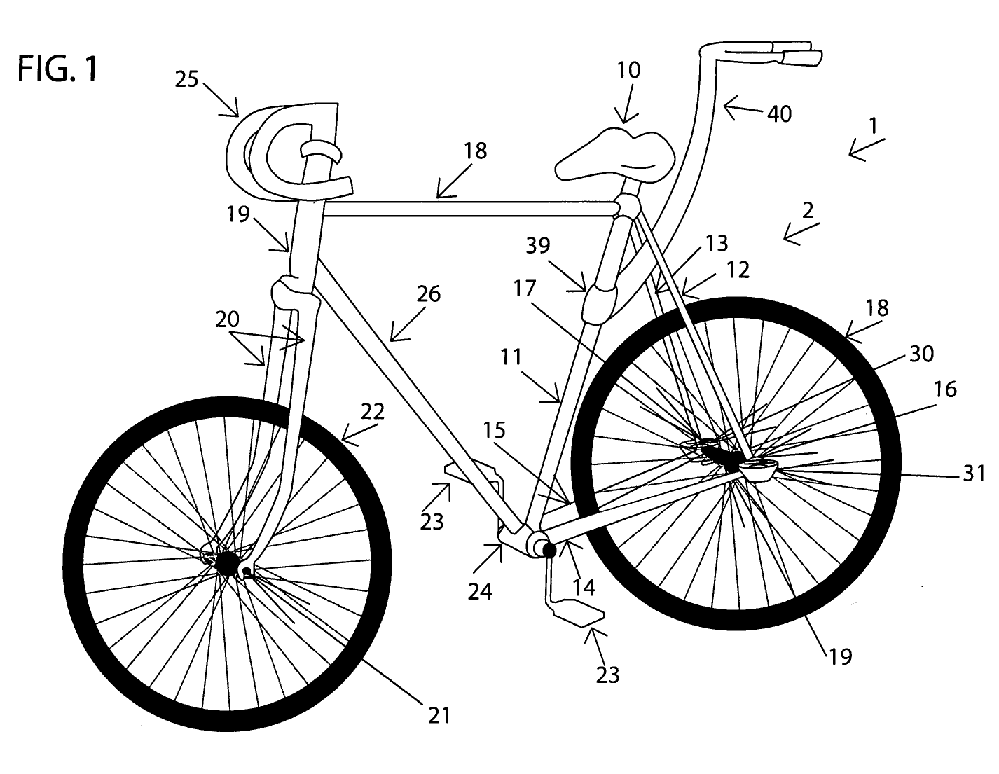

Referring now to the drawings wherein like numerals refer to like parts, FIG. 1 illustrates a bicycle 1 in an embodiment of the present invention. The bicycle 1 may have a frame 2 having a seat 10, a seat post 11, a left seat stay 12, a right seat stay 13, a left chain stay 14 and a right chain stay 15. The left chain stay 14 may be attached to the left seat stay 12 at a left connection point 16, and/or the right chain stay 15 may be attached to the right seat stay 13 at a right connection point 17. A rear wheel 18 may reside between the left seat stay 12 and the right seat stay 13 and/or between the left chain stay 14 and the right chain stay 15. The rear wheel 18 may be connected to a rear axle 19 that may reside between the left connection point 16 and the right connection point 17. A top tube 18 may be attached to the seat post 11. The top tube 18 may be attached to a head tube 19 that may be substantially perpendicular to the top tube 18. Forks 20 may project from the head tube 19 and/or may be connected to a front axle 21 and/or a front wheel 22. Pedals 23 may be connected to the frame 2 by a bracket 24. A bicycle handle 25 may be attached to the head tube 19. A down tube 26 may extend from the head tube 19 and connect to the seat post 11 at the bracket 24 as generally illustrated in FIG. 1. A rider may ride the bicycle 1 by sitting on the seat 10 and turning the pedals 23.

A left footpeg 30 and/or a right footpeg 31 may attach to the left connection point 16 and/or the right connection point 17, respectively, of the frame 2 of the bicycle 1. The left footpeg 30 and/or the right footpeg 31 may connect to the rear axle 19. An additional rider may place a left foot and/or a right foot on the left footpeg 30 and/or the right footpeg 31, respectively, and thereby ride on the bicycle 1 in a standing position.

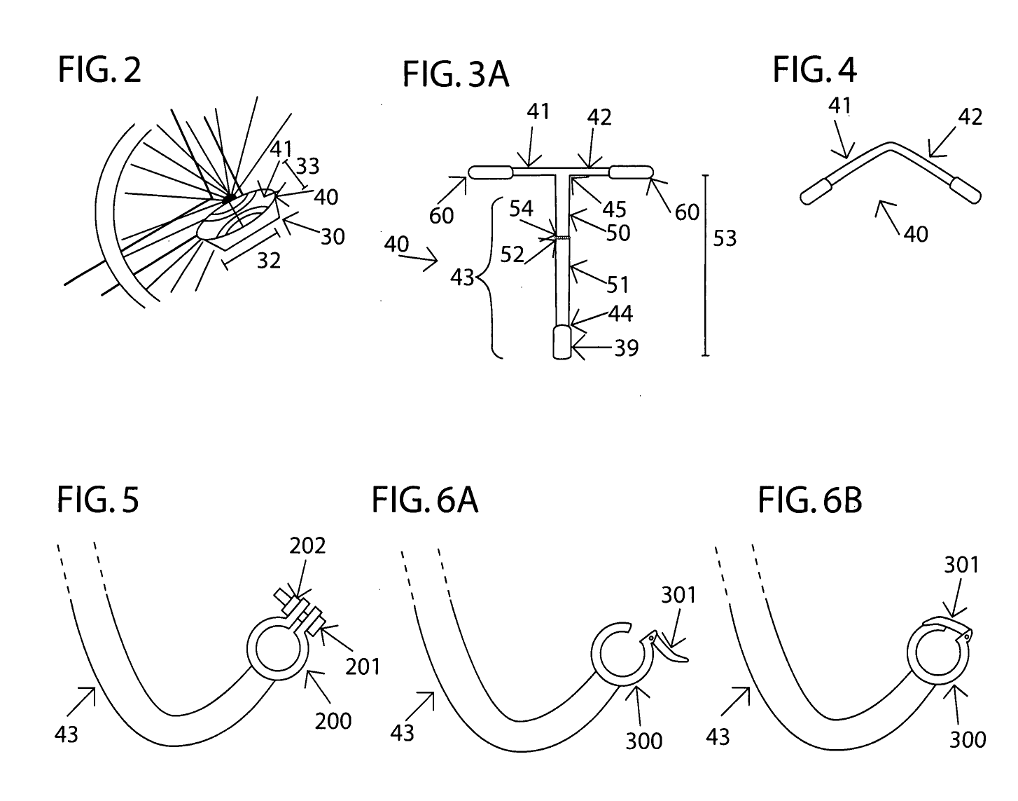

As generally illustrated in FIG. 2, the left footpeg 30 and/or the right footpeg 31 may have upper surfaces 40. The upper surfaces 40 may be substantially planar to maximize surface area upon which the additional rider may place the left foot and/or the right foot. The upper surfaces 40 may have grooves 41 that extend into the upper surfaces 40. The grooves 41 may prevent the left foot and/or the right foot from slipping from the left footpeg 30 and/or the right footpeg 31, respectively. The upper surfaces 40 may extend in a forward direction and/or a rearward direction relative to the bicycle 1 to maximize surface area upon which the additional rider may place the left foot and/or the right foot. In a preferred embodiment, the left footpeg 30 and/or the right footpeg 31 may be an oval shape so that a length 32 of the left footpeg 30 and/or the right footpeg 31 may be greater than a width 33 of the left footpeg 30 and/or the right footpeg 31.

Referring again to FIG. 1, an additional bicycle handle 40 may be secured to the frame 2 of the bicycle 1 so that an additional rider 11 may grasp the additional bicycle handle 30 while standing on the left footpeg 30 and/or the right footpeg 31. Securing the additional bicycle handle 40 to the seat post 11 of the frame 2 of the bicycle 1 may anchor the additional bicycle handle 30 in a fixed position relative to the bicycle 1. Preferably, disconnection of the additional bicycle handle 30 may not occur during operation of the bicycle 1. The additional bicycle handle 40 may be connected to the seat post 11 by a connector 39 and/or may be disconnected from the seat post 11 by unfastening the connector 39.

The additional bicycle handle 40 may be connected to the seat post 11 of the frame 2 of the bicycle 1 if the additional rider is riding the bicycle 1. The additional bicycle handle 30 may be disconnected from the seat post 11 of the frame 2 of the bicycle 1 if the rider rides the bicycle without the additional rider. The additional bicycle handle 40 may be connected to the seat post 11 of the frame 2 of the bicycle 1 at any point between the seat 10 and the left seat stay 12 and the right seat stay 13.

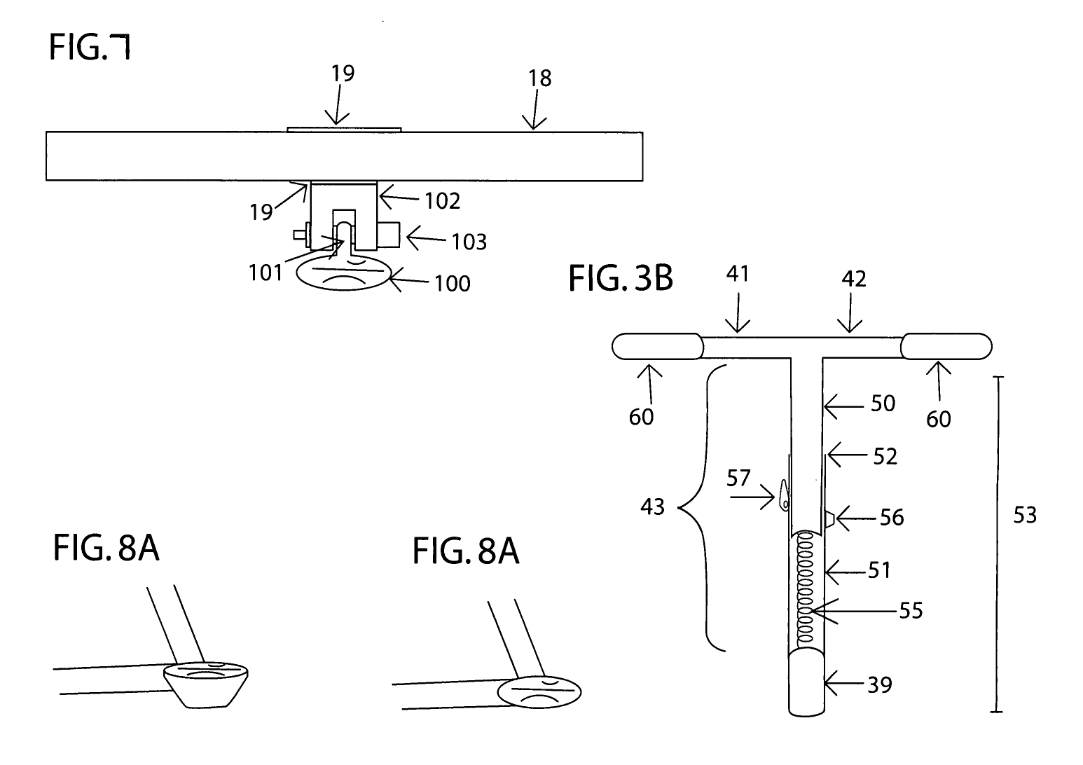

As generally shown in FIG. 3A, the additional bicycle handle 40 may be a “T” shape. The additional bicycle handle 40 may have a left bar 41, a right bar 42 and a linkage post 43. The linkage post 43 may curve to allow the additional bicycle handle 40 to connect to the seat post 11 and extend above the seat 10. The linkage post 43 may be attached to the connector 39 at a first end 44 of the linkage post 43. The left bar 41, the right bar 42 and/or the linkage post 43 may be integrally formed, welded together or connected by any means known to one having ordinary skill in the art. The left bar 41 and/or the right bar 42 may be connected to the linkage post 43 at a second end 45 of the linkage post 43.

The left bar 40 and/or the right bar 41 may have handle portions 60. The handle portions 60 may be manufactured from a material that is less rigid than a material from which the linkage post 43 and/or the frame 2 of the bicycle 2 are manufactured. The less rigid material of the handle portions 60 may allow the additional rider to comfortably grasp the additional bicycle handle 40. In a preferred embodiment, the handle portions 60 may be manufactured from rubber, and/or the linkage post 43 may be manufactured from metal. The material of the handle portions 60 and/or the linkage post 43 should not be limited to a specific material. It should be understood that the material of the handle portions 60 and/or the linkage post 43 may be any material as known to one having ordinary skill in the art.

The linkage post 43 may have a first bar 50 and/or a second bar 51. The first bar 50 may have a smaller radius than the second bar 51. The second bar 51 may be hollow. The first bar 50 may insert into an opening 52 in the second bar 51. The first bar 50 may be inserted further into the second bar 51 to decrease a height 53 of the linkage post 43. The first bar 50 may be pulled from the opening 52 of the second bar 51 to increase the height 53 of the linkage post 43. The opening 52 may have a seal 54 so that after the height of the linkage post 43 is adjusted, the seal 54 holds the first bar 50 in a fixed position relative to the second bar 51. An increase and/or a decrease of the height 53 of the linkage post 43 may allow a position of the additional bicycle handle 30 to be adjusted to correspond to a height of the additional rider. Adjusting the position of the additional bicycle handle 40 to correspond to the height of the additional rider may allow the additional rider to comfortably grasp the additional bicycle handle 40.

As generally shown in FIG. 3B, a spring 55 may be connected to the first bar 50 and/or may be located inside the second bar 51. The spring 55 may prevent movement of the first bar 50 relative to the second bar 51. For example, the spring 55 may counteract a weight of the additional rider and/or may prevent the weight of the additional rider from pushing the first bar 50 further within the second bar 51.

The second bar 51 may have a button 56. The button 56 may maintain a position of the second bar 51 within the first bar 50. Pushing the button 56 may allow the second bar 51 to move to a new position relative to the first bar 50. Pushing the button 56 and/or movement of the second bar 51 relative to the first bar 50 may adjust the height 43 of the linkage post 43.

The second bar 51 may have a latch 57. A first position of the latch 57 may maintain a position of the second bar 51 within the first bar 50. A second position of the latch 57 may allow movement of the second bar 51 relative to the first bar 50. Positioning of the latch 57 and/or movement of the second bar 51 relative to the first bar 50 may adjust the height 43 of the linkage post 43.

As generally shown in FIG. 4, the left bar 41 and the right bar 42 may be angled relative to each other so that the left bar 41 and the right bar 42 are not co-linear. The left bar 41 and the right bar 42 may be angled in a direction toward the additional rider to provide a comfortable grip for the additional rider.

As previously set forth, the additional bicycle handle 40 may be connected to the seat post 11 by a connector 39 and/or may be disconnected from the seat post 11 by unfastening the connector 39. The connector 39 may be an “O” clamp 200 as generally shown in FIG. 5. The clamp 200 and the linkage post 43 may be integrally formed, welded together or connected by any means known to one having ordinary skill in the art. A bolt 201 may extend through the clamp 200. The bolt 201 may be located on a side of the seat post 11 that may be opposite in position to the linkage post 43. The seat post 43 may be positioned within the clamp 200. A nut 202 may attach to the bolt 201 and may maintain a connection of the clamp 200 to the seat post 11. The connection of the clamp 200 to the seat post 11 may connect the linkage post 43 to the seat post 11. To connect the additional bicycle handle 40 to the seat post 11, the clamp 200 may be placed around the seat post 11, the bolt 201 may be inserted through the clamp 200 and/or the nut 202 may be tightened on the bolt 201. To remove the additional bicycle handle 40 from the seat post 11, the nut 202 may be loosened on the bolt 201, the bolt 201 may be disconnected from the clamp 200 and/or the clamp 200 may be disconnected from the seat post 11.

The connector 39 may be a latch clamp 300 as generally shown in FIGS. 6A and 6B. The latch clamp 300 and the linkage post 43 may be integrally formed, welded together or connected by any means known to one having ordinary skill in the art. A latch 301 may be connected to the latch clamp 300. The latch 301 may be in an “open” position as generally illustrated in FIG. 6A, or the latch 301 may be in a “closed” position as generally illustrated in FIG. 6B. The seat post 43 may be positioned within the latch clamp 300. Positioning the latch 301 in the “closed” position may connect the latch clamp 301 to the seat post 11. Connection of the latch clamp 300 to the seat post 11 may connect the linkage post 43 to the seat post 11. To connect the additional bicycle handle 40 to the seat post 11, the latch clamp 300 may be placed around the seat post 11, and/or the latch 301 may be closed. To remove the additional bicycle handle 40 from the seat post 11, the latch 301 may be opened, and/or the latch clamp 300 may be disconnected from the seat post 11.

The connector 39 should not be limited to a specific embodiment of the connector 39 previously described. It should be understood that the connector 39 may be any connecting means known to one having ordinary skill in the art.

As generally shown in FIG. 7, an adaptor 102 may be connected to the rear axle 19. The footpeg 100 may have a projection 101 that may connect the footpeg 100 to the adaptor 102. The adaptor 102 may be connected to the projection 101 by a bolt 103. The bolt 103 may extend through the adaptor 102 and/or the projection 101. A nut 104 may attach to the bolt 103 and may maintain a connection of the projection 101 to the adaptor 102. The connection of the adaptor 102 to the rear axle 19 may connect the footpeg 100 to the rear axle 19. The adaptor 102 may connect to the rear axle 19 via threading on the rear axle 19 and/or within the adaptor 102. The connection of the footpeg 100 to the adaptor 102 and the connection of the footpeg 100 to the rear axle 19 should not be limited to specific embodiments. It should be understood that the connection of the footpeg 100 to the adaptor 102 and the connection of the footpeg 100 to the rear axle 19 may be by any means known to one having ordinary skill in the art.

As generally shown in FIG. 8A, the footpeg 100 may be in a horizontal position. The horizontal position may orient the footpeg 100 substantially perpendicular to the rear wheel 18. As generally shown in FIG. 8B, the footpeg 100 may rotate away from the horizontal position. The footpeg 100 may rotate around the bolt 103 to a downward position substantially parallel to the rear wheel 18. The footpeg 100 may rotate to the downward position substantially parallel to the rear wheel 18 if the footpeg 100 is not in use by the additional rider. Rotating the footpeg 100 to the downward position substantially parallel to the rear wheel 18 may prevent the footpeg 100 from extending from the bicycle 1 and/or contacting objects passed by the bicycle 1 during use of the bicycle 1. The nut 104 may be tightened on the bolt 103 to maintain the downward position substantially parallel to the rear wheel 18.

Conversely, if the additional rider may use the bicycle 1, the footpeg 100 may rotate from the downward position to the horizontal position as generally shown in FIG. 8A. The footpeg 100 may rotate to the horizontal position by rotation around the bolt 103. The nut 104 may be loosened on the bolt 103 to allow rotation of the footpeg 100 from the downward position substantially parallel to the rear wheel 18. If the footpeg 100 is rotated to the horizontal position, the nut 100 may be tightened on the bolt 103 to maintain the horizontal position of the footpeg 100.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. A bicycle handle for attachment to a bicycle wherein the bicycle has a front end, a back end, a first handle, a front wheel located at the front end, a back wheel located at the back end, a seat and a seat post wherein the first handle is adjacent to the front wheel wherein the seat is connected to the back wheel by the seat post and further wherein the bicycle handle attaches to the seat post in a position adjacent to the back wheel and the back end, the bicycle handle comprising:
a post having a first end and a second end wherein the first end and the second end define a length of the post;
a first handlebar that extends from the first end of the post wherein the first handlebar is substantially perpendicular to the post;
a second handlebar that extends from the first end of the post wherein the second handlebar is substantially perpendicular to the post; and
connecting means attached to the second end of the post.

2. The bicycle handle of claim 1 further comprising:
a first rod and a second rod wherein the first rod and the second rod form the post and further wherein movement of the first rod relative to the second rod adjusts the length of the post.

3. The bicycle handle of claim 1 further comprising:
a latch that extends from the connecting means wherein the latch moves between a first position and a second position.

4. The bicycle handle of claim 1 further comprising:
handle portions on the first handlebar and the second handlebar wherein the first handlebar and the second handlebar are manufactured from a first material, the handle portions are manufactured from a second material and the second material is softer than the first material.

5. The bicycle handle of claim 1 further comprising:
a fastener attached to the connecting means wherein the connecting means has an open configuration and a closed configuration and adjustment of the fastener moves the connecting means between the open configuration and the closed configuration.

6. The bicycle handle of claim 1 further comprising:
a latch on the post wherein the latch moves between a first position and a second position wherein moving the latch from the first position to the second position adjusts the length of the post.

7. A system for transporting an additional rider on a bicycle wherein the bicycle has a first handlebar, a front wheel, a rear wheel, a seat and a seat post wherein the first handlebar is adjacent to the front wheel and the seat is connected to the rear wheel by the seat post and further wherein the system attaches to the seat post in a position adjacent to the back wheel, the system comprising:
a post having a first rod and a second rod wherein the first rod has a first end and a second end and the second rod has a first end and a second end and further wherein the second end of the second rod is connected to the first end of the first rod and further wherein a length of the post is defined by a distance between the first end of the second rod and the second end of the first rod;
a third rod that extends from the first end of the second rod;
a fourth rod that extends from the first end of the second rod; and
connecting means attached to the second end of the second rod.

8. The system of claim 7 further comprising:
a spring connected to the first rod and the second rod.

9. The system of claim 7 further comprising:
an opening at the first end of the first rod wherein the second end of the second rod is located within the opening.

10. The system of claim 7 further comprising:
a latch on the post wherein the latch moves between a first position and a second position wherein moving the latch from the first position to the second position adjusts the length of the post.

11. The system of claim 7 further comprising:
a button on the post wherein pressing the button allows movement of the first rod relative to the second rod.

12. The system of claim 7 further comprising:
pegs adjacent to the connecting means wherein each of the pegs has a flat surface.

13. The system of claim 7 further comprising:
pegs adjacent to the connecting means wherein each of the pegs rotates from a horizontal position to a downward position.

14. A method for transporting an additional rider on a bicycle wherein the bicycle has a first handle, a seat post, a front wheel and a rear wheel wherein the first handle is adjacent to the front wheel, the method comprising the steps of:
connecting a second handle to the seat post wherein the second handle has a post having a first end and a second end and further wherein the first end and the second end define a length of the post wherein a first handlebar and a second handlebar are connected to the first end of the post and further wherein the second end of the post connects to the seat post of the bicycle wherein the second handle has a connector attached to the second end of the post wherein the connector attaches to the seat post of the bicycle and de-attaches from the seat post of the bicycle; and
moving the bicycle wherein the bicycle is moved with the additional rider holding the second handle.

15. The method of claim 14 further comprising the step of:
adjusting the length of the post of the second handle.

16. The method of claim 14 further comprising the step of:
attaching pegs to the rear wheel of the bicycle wherein each of the pegs has a flat surface.

17. The method of claim 14 further comprising the steps of:
attaching pegs to the rear wheel of the bicycle wherein the pegs rotate from a downward position to a substantially horizontal position.

18. The method of claim 14 further comprising the step of:
moving a latch on the post of the second handle from a first position to a second position wherein the first position is located opposite to the second position.

19. The method of claim 14 further comprising the step of:
moving a latch on the connector from a first position to a second position wherein the first position is located opposite to the second position.

20. The method of claim 14 further comprising the step of:
removing the second handle from the bicycle wherein de-attaching the connector from the seat post removes the second handle from the bicycle and further wherein reconnecting the connector to the seat post of the bicycle re-attaches the second bicycle handle to the bicycle.
